(19) United States
(12) Patent Application Publication
(10) Pub. No.: US 2018/0142721 A1
(43) Pub. Date: May 24, 2018

(54) SELF LOCKING NUT AND MANUFACTURING METHOD THEREOF

(71) Applicant: Hoon Sik Kang, Jeollabuk-do (KR)

(72) Inventor: Hoon Sik Kang, Jeollabuk-do (KR)

(21) Appl. No.: 14/371,601

(22) PCT Filed: Jan. 10, 2012
(86) PCT No.: PCT/KR2012/011870

§ 371 Date: Jul. 10, 2014

(30) Foreign Application Priority Data
Jan. 10, 2012 (FR) 10-2012-0002967

(51) Int. Cl. F16B 39/282; F16B 39/286

(52) U.S. Cl. CPC F16B 39/282; F16B 39/286

(57) ABSTRACT

Provided is a self locking nut and a manufacturing method thereof wherein a body is spiral and has elasticity, and threads are formed in an inner circumferential surface and are engaged to the bolt. The spiral body of the nut is engaged strongly surrounding the bolt. The spiral body expands or contracts depending on the change of temperature, so the threads of the nut and the bolt comes into strong contact with each other for thereby obtaining stable engagement. In case that external force such as vibrations or impacts is applied, the external force may be absorbed elastically, thus preventing the loosening of the nut.

### BACKGROUND

The present invention relates to a self locking nut and a manufacturing method thereof, and particularly to a self locking nut and a manufacturing method thereof which make it possible to prevent the loosening of a nut even when the nut is used under environment where vibrations or external forces continuously generate.

When a nut engaged to a bolt is exposed for long time to environment where vibrations repeatedly generate, slipping phenomenon occurs in the threads of the bolt and the nut, which leads to loosening the nut because a locking state of when the nut is initially engaged to the bolt is not maintained.

When the nut is loosened, serious problems may occur in a train rail bridge or a river bridge or wheels of a vehicle or various machines where vibrations occur. So, it is necessary to continuously check the states of engaged nuts.

There has been an effort to reduce the loosening of nuts. As an example, Korean Patent Registration No. 10-0398934 (Sep. 29, 2003) provides a nut with a loosening prevention spring.

However, the related nut is engaged to the bolt in a state that an additional spring is disposed in the interior of the nut. In this case, there should be additionally provided a spring. Since the spring is disposed between the bolt and the nut, the spring may interfere with the engagement of the nut, so it is uneasy to use the related nut. In a state that the related nut is engaged and used, if vibrations are continuously applied, and the spring may receive pressures, the spring may be easily damaged.

### SUMMARY OF THE INVENTION

Accordingly, it is an object of the present invention to provide a self locking nut and a manufacturing method thereof which make it possible to provide a structural stability in such a way to obtain a stably engaged state because an initially engaged state is not loosened even when the self locking nut of the present invention is used under environment where vibrations continuously generate.

To achieve the above object, there are provided a self locking nut and a manufacturing method thereof wherein the threads of the nut and the bolt are strongly tightened and engaged by supplying elasticity to the nut, so the nut efficiently absorbs vibrations even when the vibrations are applied in the engaged state for thereby preventing the loosening of the engaged nut.

According to the present invention, a spirally shaped body may be strongly tightened and engaged. The threads of the nut and the bolt may come into close contact with each other and may be strongly engaged because the spirally shaped body contracts or expands depending on the change of temperature. If an external force such as external vibrations or impacts is applied, the engaged nut may elastically absorb the external force, so the engaged nut may not be easily loosened.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a self locking nut wherein a spirally cut-away groove is formed in a part of a body according to the present invention;

FIG. 2 is a front view of FIG. 1;

FIG. 3 is a perspective view illustrating a self locking nut wherein a spirally cut-away groove passes through an end of a body according to another exemplary embodiment of the present invention;

FIG. 4 is a front view of FIG. 3;

FIG. 5 is an exemplary state view illustrating a state that an end of a body of a self locking nut looks blunt, wherein a spirally cut-away groove passes through an end of a body;

FIG. 6 is a perspective view illustrating a self locking nut wherein a spirally cut-away groove is formed at an end of a slanted groove according to the present invention;

FIG. 7 is a front view of FIG. 6;

FIGS. 8 and 9 are exemplary views illustrating a slanted groove according to another exemplary embodiment of the present invention;

FIGS. 10 to 14 are exemplary views illustrating a manufacturing procedure of a self locking nut wherein a spirally cut-away groove passes through an end of a body according to the present invention;

FIGS. 15 to 19 are exemplary views illustrating the manufacturing procedures of a self locking nut wherein a spirally cut-away groove is formed in a part of a body and of a self locking nut wherein a slanted groove is formed in an end of a spirally cut-away groove according to the present invention; and

FIG. 20 is a perspective view illustrating a nut wherein the length of a body is long according to the present invention.

### DETAILED DESCRIPTION OF THE INVENTION

The present invention is directed to a self locking nut and a manufacturing method thereof which are characterized in that even when a self locking nut of the present invention is used under environment where vibrations continuously generate, a tightening state of when a self locking nut is initially engaged is not loosened, thus obtaining a stably engaged state and a structurally stable state because a body is formed in a spiral shape to have elasticity, and threads are formed along an inner circumferential surface of the nut and are engaged to the bolt.

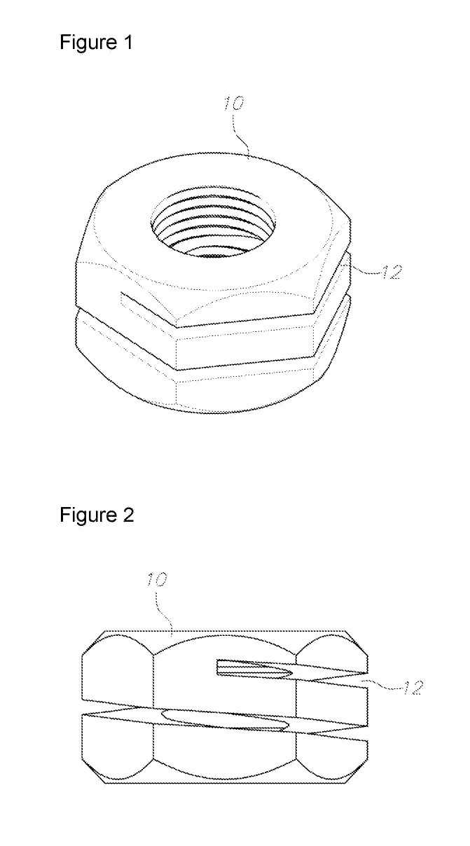

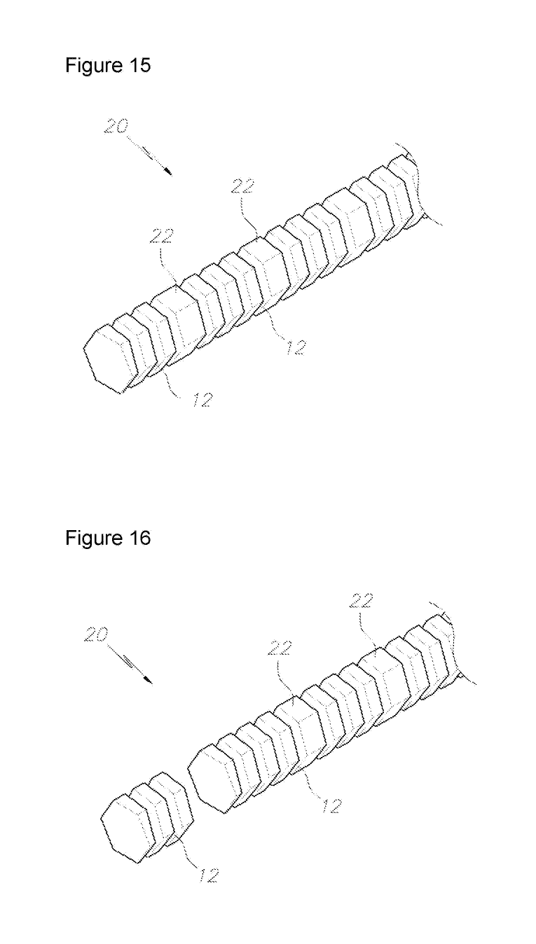

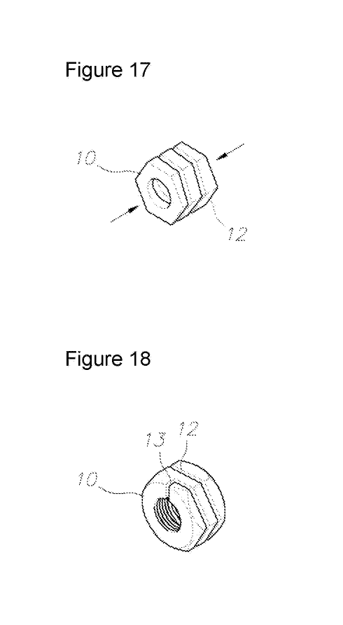

The present invention will be described with reference to FIGS. 1 to 20.

The self locking nut according to the present invention comprises a spirally shaped body 10 whose cross section may be formed in any of a triangle shape, a quadrangle shape, a pentagonal shape and a hexagonal shape.

The number of when the body 10 is wound in a spiral shape and the number of treads formed in the interior of the body 10 may be adjusted if necessary. In the present invention, it is preferred that the body 10 is wound one time, and at least two threads are formed in the interior of the body 10.

If the number of when the body 10 is wound less than one time, it is hard to generate uniform elasticity, so the body 10 should be wound at least one time in a spiral shape. If the number of when the body 10 is wound increases, elasticity increases accordingly. So, the number of the windings should be determined in consideration of the above matter.

If the number of the threads formed in the inner circumferential surface of the body 10 is less than 2, it is hard to have an inherent tightening force of the nut. So, it needs to form at least two threads in the inner circumferential surface of the body 10.

In an ordinary case, the number of when the body 10 is wound in a spiral shape and the number of the treads increase if the length of the nut increases. Both the numbers may be adjusted depending on the levels of vibrations and impacts in the places where the nuts are actually used. Both the numbers should be determined in comprehensive consideration of all the above-mentioned matters.

The body 10 of the nut may be formed in a spiral shape in such a way that there is provided a spirally cut-away groove 12 configured to cut away the body 10 in a spiral shape in a longitudinal direction of the body. The spirally cut-away groove 12 is formed at a predetermined slanted angle while cutting away the body 10 in a spiral shape. At this time, it is preferred that the slanted angle of the spirally cut-away groove 12 is about 5 to 15 degrees, but not limited thereto. The slanted angle of the spirally cut-away groove 12 may be determined in consideration of the type of the nut and the length and use place of the nut.

In addition, it is preferred that the spirally cut-away groove 12 has the same widths over all the portions. The intermediate portions of the body 10 have the same thickness, thus uniformly absorbing elasticity, but limited thereto. The widths of the spirally cut-away groove 12 may be different, if necessary.

When the self locking nut of the present invention is engaged and strongly tightened, the spiral body 10 surrounds the bolt, and in the nut, there occur pushing and pulling force in an axial direction by means of an elasticity like a spring. The inner diameter is reduced, strongly tightening. So, the engaging force of the nut becomes maximized.

In a state that the nut is engaged, when external force such as vibrations or impact are applied, the nut absorbs the external force like the spring absorbs elasticity while maintaining the engaged state. The spiral body 10 expands or contracts under environment where thermal contraction or thermal expansion occurs. At this time, since the threads formed in the inner circumferential surface of the nut and the threads of the bolt come into close contact with each other with strong pressure, it is possible to maintain stably engaged state.

Various exemplary embodiments of the present invention will be described.

FIG. 1 is a perspective view illustrating a self locking nut wherein a spirally cut-away groove is formed in a part of a body according to the present invention, and FIG. 2 is a front view of FIG. 1.

As shown in FIGS. 1 and 2, in the nut according to the present invention, the spirally cut-away groove 12 may be formed in only an intermediate portion of the body 10. More specifically, the spirally cut-away groove 12 does not pass through up to the end of the body 10 of the nut. In the drawings, the spirally cut-away groove 12 is formed, not disconnected. The spirally cut-away groove 12 which is wound at least one time may be formed at regular intervals in the body 10 of the nut.

When an end of one side of the nut of the present invention is strongly tightened, the spirally body 10 strongly surrounds the bolt, and the inner diameter of the nut reduces while strongly tightening the bolt. In this construction, only the inner diameter of the intermediate portion of the nut where the spirally cut-away groove 12 is formed reduces, thus tightening the bolt. The inner diameters of the ends of both sides of the nut don't change.

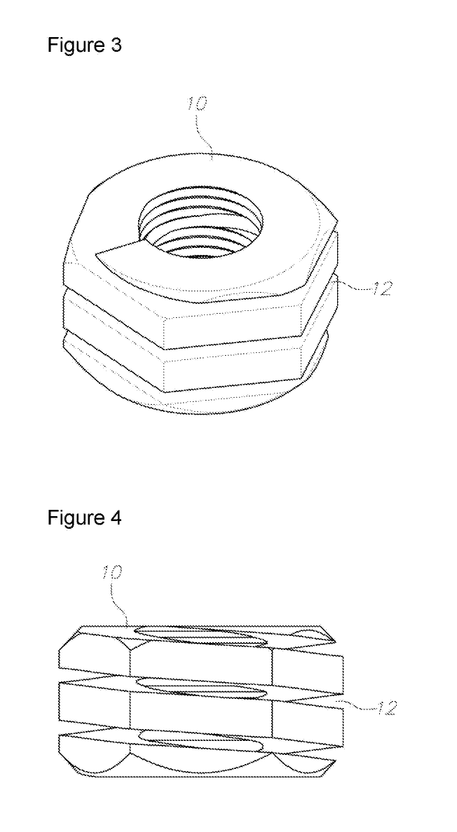

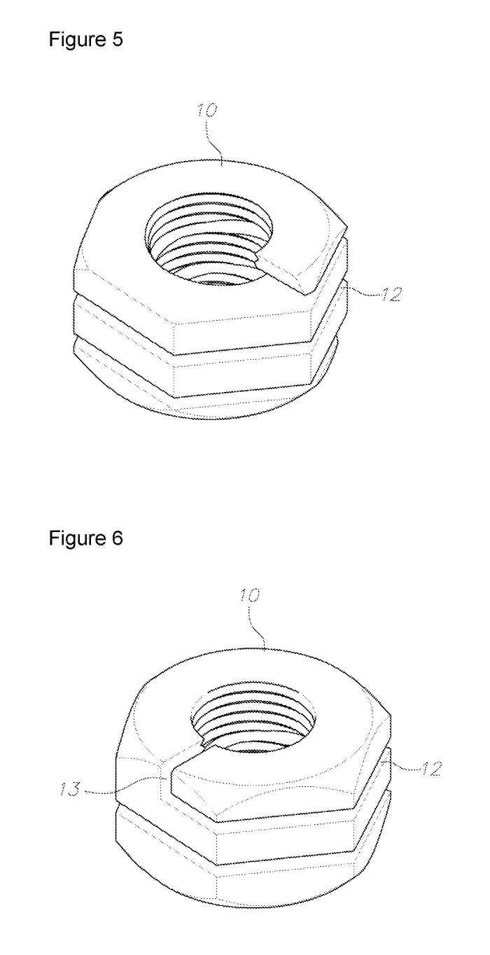

FIG. 3 is a perspective view illustrating a self locking nut wherein a spirally cut-away groove passes through an end of a body according to another exemplary embodiment of the present invention. FIG. 4 is a front view of FIG. 3. FIG. 5 is an exemplary state view illustrating a state that an end of a body of a self locking nut looks blunt, wherein a spirally cut-away groove passes through an end of a body.

As shown in FIGS. 3 and 4, the spirally cut-away groove 12 is formed to pass through up to the end of the body 10 of the nut. At this time, the spirally cut-away groove 12 may be formed in a spiral shape at the same slanted angle and with the same widths in all portions.

In the above-described construction, when an end of one side of the nut is strongly tightened, the force of pushing and pulling the nut in an axial direction of the threads like a spring is applied to the whole portions of the spiral body by means of an elasticity. As the inner diameter of the nut reduces, the bolt is strongly tightened, thus maximizing the tightening effects.

Here, the thicknesses of the portions of both ends of the spiral body 10 gradually decrease in the directions of both the ends because it needs to make planar the cross sections of both sides. In this construction, the ends of the body 10 are made thin and exposed to the outside, so the thin ends may be bent or broken by external force. This problem becomes more serious if the slope of the spirally cut-away groove 12 is low, and the width of the spirally cut-away groove 12 increases. As shown in FIG. 5, so as to overcome the above-mentioned problem, it needs to make blunt the ends of the body 10 by cutting out the ends of the body 10.

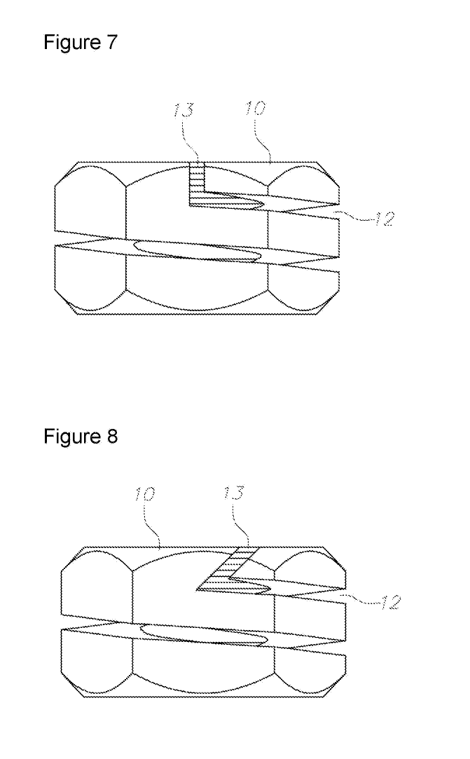

FIG. 6 is a perspective view illustrating a self locking nut wherein a spirally cut-away groove is formed at an end of a slanted groove according to the present invention, and FIG. 7 is a front view of FIG. 6.

As shown in FIGS. 6 and 7, the spirally cut-away groove 12 may be formed in such a way that a slanted groove 13 passing through up to the end of the body 10 is bent at an end of the body 10 and is slanted.

The slanted groove 13 allows the end of the spiral body 10 to have uniform thickness and also allows the end of the body 10 to be hidden from the outside.

It is preferred that the slanted angle of the slanted groove 13 is almost vertical with respect to the traversing surface of the body 10 of the nut, which leads to easier formation while making blunt the ends of the spiral body 10.

According to the above-described construction, as shown in FIGS. 4 and 5, it is possible to easily overcome the problems that the ends of the body 10 of the nut 10 are exposed to the outside and are damaged or broken by external force.

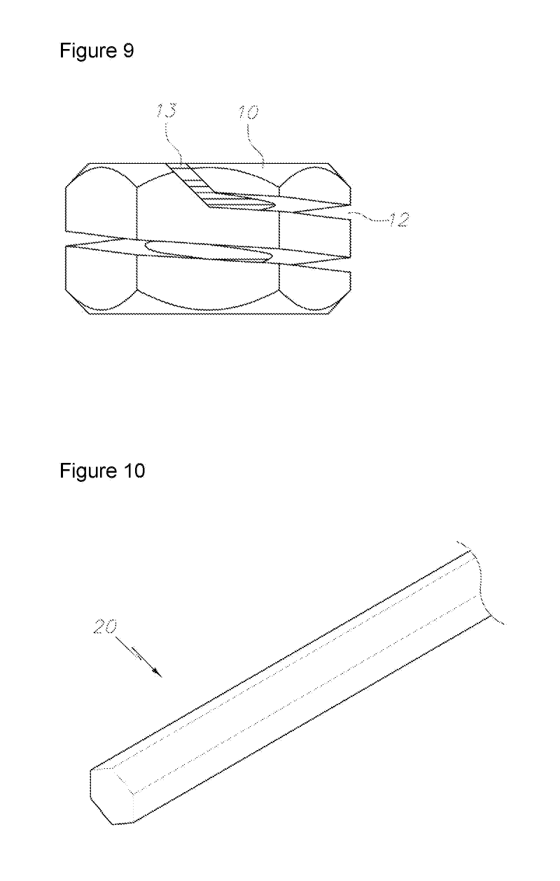

FIGS. 8 and 9 are exemplary views illustrating a slanted groove according to another exemplary embodiment of the present invention.

The slanted angle of the slanted groove 13 of the present invention may change in various ways in addition to the above disclosed slanted angle. It is preferred that the slanted angle of the slanted groove 13 may be almost vertical with respect to the traversing surface of the body 10, but not limited thereto. Various slanted angles may be provided with respect to the traversing surface of the body 10 if necessary. As shown in FIGS. 8 and 9, it is possible to provide various slanted angles, for example, an acute angle or an obtuse angle with respect to the spirally cut-away groove 12.

The self locking nut according to the present invention may be manufactured in various ways. Each manufacturing method will be described below.

FIGS. 10 to 14 are exemplary views illustrating a manufacturing procedure of a self locking nut wherein a spirally cut-away groove passes through an end of a body according to the present invention.

The self locking nut according to the present invention may be manufactured using a long rod 20 with a predetermined length. For this, as show in FIG. 9, a long rod 20 with a predetermined diameter is prepared. An outer circumferential surface of the long rod 20 may be identified as an outer circumferential surface of the nut. The long rod 20 may have a cross section of any of a triangle shape, a quadrangle shape, a pentagonal shape and a hexagonal shape, if necessary.

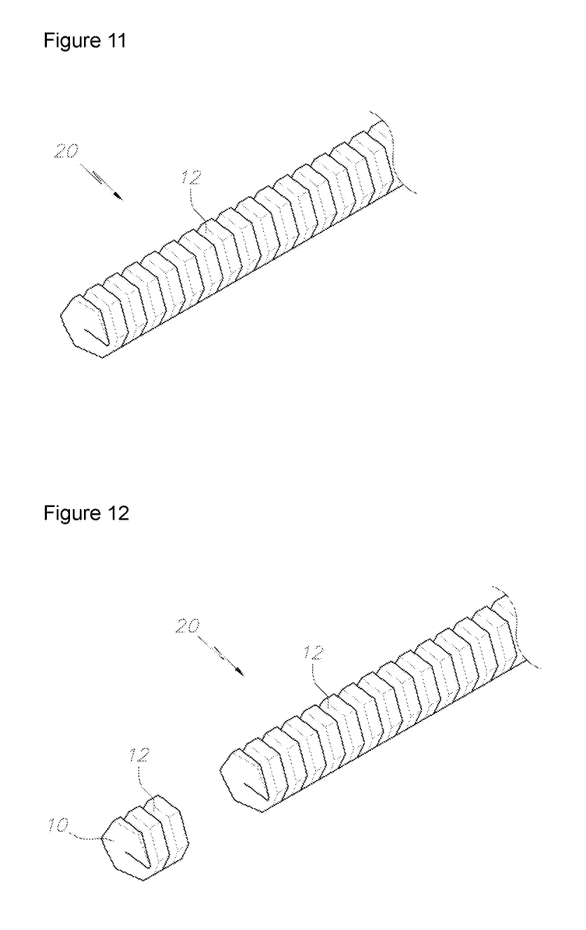

As shown in FIG. 11, when the long rod 20 is prepared, a spirally cut-away groove 12 is formed at a predetermined depth in a longitudinal direction of the long rod 20 using a cutting tool. For this, a spiral groove is formed along the body of the long rod 20 for thereby forming a spirally cut-away groove 12. At this time, a right hand thread is processed at a lead angle from left to right. A left hand thread is processed at a lead angle from right to left.

As shown in FIG. 12, the long rod 20 with a spirally cut-away groove 12 is cut in a predetermined length thus forming a body 10. At this time, it is preferred that the length of the body 10 formed through cutting is cut slightly longer than the nut which will be the finished product. The length is adjusted during the process in consideration of the contractible length.

The procedure during which the long rod with a spirally cut-away groove 12 is cut in a predetermined length may be concurrently performed along with the procedure for forming the spirally cut-away groove 12 in the long rod 20. More specifically, the spirally cut-away groove 12 is formed using a cutting tool while supplying the long rod 20 in a longitudinal direction, and a cutter is installed behind it, so the portions where the spirally cut-away groove 12 is formed are cut off in a predetermined length.

A hole is formed in the interior of the body 10 formed by cutting the long rod 20 in a predetermined length, thus forming an inner diameter of a nut. At this time, the inner diameter is processed or the spirally cut-away grove 12 to communicate with the hole formed in the interior of the body, thus obtaining a body wound in a spiral shape.

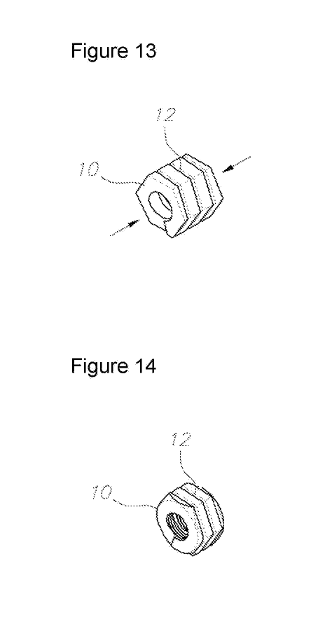

As shown in FIG. 13, the body 10 is compressed in a longitudinal direction using a compressor for thereby adjusting the length. The width of the spirally cut-away groove 12 is reduced after the above process for thereby adjusting the length of the body 10.

The procedure for compressing the cut and formed body 10 may not be performed when it does not need to adjust the length of the nut. Such a procedure may be performed for the purpose of precise process in the same way as the spirally cut-away groove 12 is formed in the nut which will be finished.

When the length of the body 10 has been properly adjusted after compression, threads are formed in the interior of the body 10. The threads are formed using a predetermined thread formation tool, and the rough surfaces are polished, so a nut wherein a spirally cut-away grove 12 is formed in a part of the body 10 is produced through finishing processes.

There may be a further procedure for widening the intervals of the spirally cut-away grooves 12 at an intermediate portion of the nut after the threads are formed or a predetermined finishing procedure is completed.

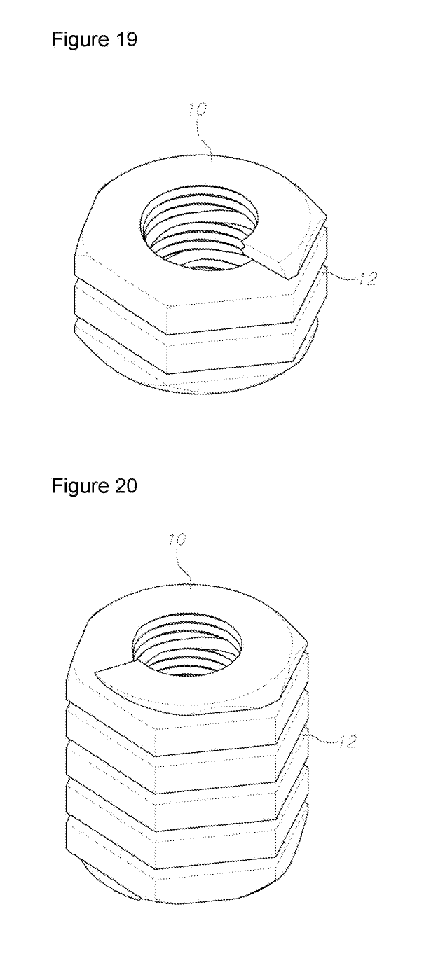

In case that a slanted groove 13 is formed at an end of the spirally cut-away groove 12, the long rod 22 is cut or the body is compressed for thereby adjusting the length, so the slanted groove 13 passing through from the end of the spirally cut-away groove 12 to the end of the body is formed. Thereafter, as show in FIG. 19, through typical finishing procedures, a nut wherein a slanted groove 13 passes through from an end of the spirally cut-away groove 12 to an end of the body is manufactured.

The above described self locking nut of the present invention may be manufactured by a cast. In this case, a spiral body 10 is cast, and after a form removing procedure, as described earlier, the procedure for compressing in a longitudinal direction, the procedure for forming threads and the procedure for finishing may be performed for thereby manufacturing the nut with a spiral body 10.

At this time, depending on the shape of the body 10 to be cast, it may pass through up to the end of the body 10 of the spirally cut-away groove 12 or it may be formed in part of the body 10. More specifically, the casting procedure may be performed in such a way that a spirally cut-away groove 12 may pass through up to the end of the body 10 or the spirally cut-away groove 12 may be formed in part, and the form removal is performed, and the length is adjusted, and the threads are formed, and the finishing procedure is performed, so it is possible to manufacture a nut wherein it passes through up to the end of the body 10 of the spirally cut-away groove 12 or it may be formed in part of the body 10.

When the spirally cut-away groove 12 is formed in part of the body 10, the procedure for forming the slanted groove 13 is performed, so it is possible to manufacture a nut wherein the slanted groove 13 is formed at the end of the spirally cut-away groove 12.

The nut with a spiral body 10 according to the present invention may have different lengths, and the nut may be manufactured in various shapes by adjusting the number of threads. For example, the nut as shown in FIG. 10 may be also manufactured.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A self locking nut, comprising:
a body which is formed in a spiral shape and is configured to have elasticity, wherein the self locking nut is engaged to a bolt with the aid of the formation of threads in an inner circumferential surface of the self locking nut.

2. The nut of claim 1, wherein the body is wound at least one time in a spiral shape, and the threads are at least two in number.

3. The nut of claim 1, wherein the nut is formed in a spiral shape since a spirally cut-away groove cutting away the body in a spiral shape is formed in a longitudinal direction.

4. The nut of claim 3, wherein the spirally cut-away groove is formed only in an intermediate portion of the body.

5. The nut of claim 3, wherein the spirally cut-away groove passes through up to an end of the body.

6. The nut of claim 5, wherein the end of the body is cut away and blunt.

7. The nut of claim 5, wherein the spirally cut-away groove is bent at an end of the body for thereby forming a slanted groove and is configured to pass through up to the end of the body.

8. The nut of claim 3, wherein parts of the threads disconnected by the spirally cut-away groove are not formed on the same spiral line but are formed deviating from one another.

9. A method for manufacturing a self locking nut, comprising:
forming at a predetermined depth a spirally cut-away groove in a long rod which has a predetermined length;
cutting the long rod, which has the spirally cut-away groove, by a predetermined length; and
forming threads in such a way to form a hole in the interior of the cut-away long rod and process an inner diameter of the long rod.

10. The method of claim 9, further comprising:
adjusting the length of the cut-away long rod by pressurizing the cut-away long rod in a longitudinal direction before the threads are formed in the cut-away long rod.

11. The nut of claim 9, wherein the spirally cut-away groove is formed along the long rod at regular intervals, and the portions between the spirally cut-away grooves are cut-away for thereby forming a nut wherein the spirally cut-away groove is formed only in an intermediate portion of the body.

12. The nut of claim 11, further comprising:
forming at an end of the spirally cut-away groove a slanted groove which passes through up to the end of the body.

13. The nut of claim 9, further comprising:
allowing the threads not to be formed on the same spiral line but to deviate from one another in such a way to form the threads in the interior of the cut-away long rod and pull the same.

14. A method for manufacturing a self locking nut, comprising:
forming a body using a cast, which body is formed in a spiral shape because of the formation of a spirally cut-way groove;
adjusting the length of the body in such a way to remove the form of the body and pressurize in a longitudinal direction; and
forming threads in the interior of the cut-away long rod.
